(19) United States
(12) Patent Application Publication
(10) Pub. No.: US 2008/0157608 A1
(43) Pub. Date: Jul. 3, 2008

(54) Electric Oscillatory Machine

(75) Inventors: Barry Reginald Hobson, Western Australia (AU); Angelo Paoliello, Western Australia (AU)

Correspondence Address: MCGARRY BAIR PC, 32 Market Ave. SW, SUITE 500, GRAND RAPIDS, MI, 49503, US

(73) Assignee: MERLEX CORPORATION PTY LTD, Bentley, WA (AU)

(21) Appl. No.: 10/598,104

(22) PCT Filed: Feb. 17, 2005
(86) PCT No.: PCT/AU2005/000207

§ 371 Date: Aug. 17, 2006

(30) Foreign Application Priority Data
Feb. 18, 2004 (US) 10781923

(51) Int. Cl. H02K 33/00; H02K 1/34

(52) U.S. Cl. 310/15

(57) ABSTRACT

An oscillatory machine (200) comprises a support (220) having a load carrying surface (222) and an opposite surface (224), an electric motor (21) having an air gap (218) through which lines of magnetic flux extend, an armature (214) coupled to the support, said armature provided with at least two electrically conductive paths [C_{A},C_{B},C_{C}] each having at least one current carrying segment disposed in the air gap and substantially perpendicularly intersected by the lines of magnetic flux (FIG. 1) to produce thrust forces [T_{A}, T_{B}, T_{C}] which act to move the armature and thus said support in two dimensions in a plane, a bearing support system (272) suspending said armature in the air gap, said bearing support system disposed between the said support and said armature.

### FIELD OF THE INVENTION

The invention relates to an electric oscillatory machine, particularly, though not exclusively, suitable to provide two dimensioned vibration, agitation or shaking.

### BACKGROUND OF THE INVENTION

Machines that provide a two-dimensional vibration, agitation or shaking motion have been used widely in various industries. Examples of such machines include pulverizing mills that grind mineral samples into fine powder, screens for screening particles on the basis of size and devices for mixing or shaking chemical or biological samples.

Traditionally such machines have incorporated an electric motor that drives an eccentrically weighted shaft to which a platform is coupled by a spring mounting. Mechanical couplings such as a gear box, belt or universal joint are typically used to couple the output of a motor to the shaft.

The very motion that these machines are designed to produce also leads to their inevitable and frequent failure. Further, the characteristics of the vibration, agitation or shaking provided by such machines is fixed at the design and construction phase. Therefore if for example different amplitudes or frequency of vibration are required different machines need to be used.

This problem has been partially addressed in the shaker described in U.S. Pat. No. 6,322,243. This U.S. patent describes a shaker producing a two-dimensional shaking motion with independent mechanical control over motion in the X and Y directions. The shaker employs a pair of track assemblies, each track assembly comprising a pair of fixed rods and a pair of sliding rods that are interconnected with each other in a rectangular, grid-like pattern. Motion in both the X and Y directions can be produced by a single motor utilizing independent pulley and belt systems or by two synchronized motors are connected to a sliding rod of each track assembly. By altering the relative amplitude, phase angle and frequency between the X and Y directions, the shaking action can follow a desired path.

US patent application publication No. 2001/0030906 describes an electromagnetic vibratory shaker which provides both horizontal and vertical displacement of a support tray. The shaker has an electromagnetic drive essentially in the form of a solenoid which is attached to a bracket supporting the tray. The bracket is also coupled by a number of leaf springs to a base that houses the electromagnetic drive. The electromagnetic drive is disposed along a line inclined by about 20° to the horizontal. Further, the springs are inclined by approximately 20° to the vertical. Upon energizing the electromagnetic drive, the drive acts to pull the bracket down and backwards against the bias of the leaf springs.

When de-energized, the springs provide a return force. Thus by applying a pulse wave, the shaker produces a cyclical vibration with both horizontal and vertical components.

### SUMMARY OF THE INVENTION

According to the invention there is provided an oscillatory machine comprising:

a support having a load carrying surface and an opposite surface;

an electric motor having an airgap through which lines of magnetic flux extend, and an armature coupled to said support, the armature provided with at least two electrically conductive paths each having at least one current carrying segment disposed in the airgap and substantially perpendicularly intersected by the lines of magnetic flux to produce thrust forces which act to move the armature and thus the support in two dimensions in a plane; and,

a bearing support system suspending said armature in said airgap, said bearing support system disposed between said support and said armature.

In one embodiment the bearing support system comprises at least three ball roller assemblies, each ball roller assembly comprising a ball roller and a roller support surface on which the ball roller rolls. The roller support surface is located in a plane between the support and the armature.

Each roller support surface may comprise a planar surface that is substantially parallel to a plane containing the support.

In an alternate embodiment the roller support surface comprises one or more planar surface portions that lie in planes non-parallel to the plane containing the support.

In a further alternate embodiment each roller support surface comprises a concavely curved surface.

Optionally the oscillatory motor further comprises a motor body and a restraint system coupled to the platform and the motor body, restraining twisting motion of the platform.

In one embodiment the restraint system comprises a parallelogram arrangement of arms comprising first and second arms pivotally coupled together intermediate their respective lengths, each of the first and second arms having one end resiliently coupled to the motor body.

Optionally the parallelogram arrangement of arms further comprises a third arm pivotally coupled to an opposite end of the first arm, a fourth arm pivotally coupled to an opposite end of the second arm, and a fifth arm pivotally coupled to both the third and fourth arms and rigidly coupled to the platform.

Optionally the oscillatory motor further comprises a hub extending axially of and attached to the support and the armature.

Advantageously the fifth arm is rigidly attached to the hub.

The oscillatory motor may further comprise a self centering system which returns the support to a central position relative to the electric motor when the electric motor is not energized.

In one embodiment, the self-centering system comprises a rod extending through the hub and resiliently coupled at opposite ends to the support and the motor body.

In an alternate embodiment the restraint system comprise a first planar spring coupled to the support and the main body. Moreover in this embodiment the restraint system further comprises a second planar spring coupled to the first planar spring and the main body.

The oscillatory machine may further comprise a rod connecting the first planar spring to the second planar spring.

The rod advantageously extends in an axial direction through the armature.

Optionally the first planar spring comprises an endless circumferential strip and a plurality of spokes radially inward of the strip and joining each other in a central web.

Advantageously the first planar spring further comprises a plurality of arms, each arm extending radially inward of the strip and terminating in a free end, the free end of each arm being attached to the support.

Optionally the second planar spring comprises an endless circumferential strip and a plurality of spokes extending radially inward of the strip and joining in a central web.

Advantageously the second planar spring further comprises a plurality of lugs extending from the endless circumferential strip of the second planar spring, the lugs being attached to the main body.

Advantageously the rod is attached to the central webs of the first and second planar springs.

### BRIEF DESCRIPTION OF THE DRAWINGS

Embodiments of the present invention will now be described by way of example only with reference to the accompanying drawings in which:

FIG. 1A is a schematic representation of a first embodiment of an electric motor that can be incorporated in the oscillatory electric machine.

FIG. 1B is an enlarged view of section A-A of FIG. 1A.

FIG. 1C is a graphical representation of a three-phase AC voltage/current supply.

FIG. 2 is a partial cut away perspective view of a second embodiment of the electric motor.

FIG. 3 is a partial cut away perspective view of a third embodiment of the electric machine.

FIG. 4 is a partial cut away perspective view of a fourth embodiment of the electric motor.

FIG. 5 is a partial cut away perspective view of a fifth embodiment of the electric motor.

FIG. 6 is a partial cut away perspective view of a sixth embodiment of the electric motor.

FIG. 7 is a partial cut away perspective view of a seventh embodiment of the electric motor.

FIG. 8A is a partial cut away perspective view of an eighth embodiment of the electric motor.

FIG. 8B is a perspective view of a support incorporated in the embodiment shown in FIG. 8A.

FIG. 9 is an exploded view of an embodiment of the oscillatory electric motor incorporating a ninth embodiment of the electric motor.

FIG. 10 is a side view of the oscillatory electric motor shown in FIG. 9.

FIG. 11 is a bottom plan view of the oscillatory electric motor shown in FIGS. 9 and 10.

FIG. 12 is an exploded view of a magnet assembly incorporated in the oscillatory electric motor.

FIG. 13 is an exploded view of an armature incorporated in the oscillatory electric motor.

FIG. 14 is a partial section view of the oscillatory electric motor shown in FIGS. 12-16.

FIG. 15 is a partial section view of a second embodiment of the oscillatory electric motor.

FIG. 16 is a partial section view of a third embodiment of the oscillatory electric motor.

FIG. 17 is a section view of a fourth embodiment of the oscillatory electric motor.

FIG. 18 is an exploded view of a sub-assembly of a fifth embodiment of the oscillatory electric motor.

FIG. 19 is a side view of the sub-assembly shown in FIG. 18, but is in assembled state.

FIG. 20 is a section view of the fifth embodiment incorporating the sub-assembly shown in FIGS. 18 and 19.

### DESCRIPTION OF THE PREFERRED EMBODIMENT

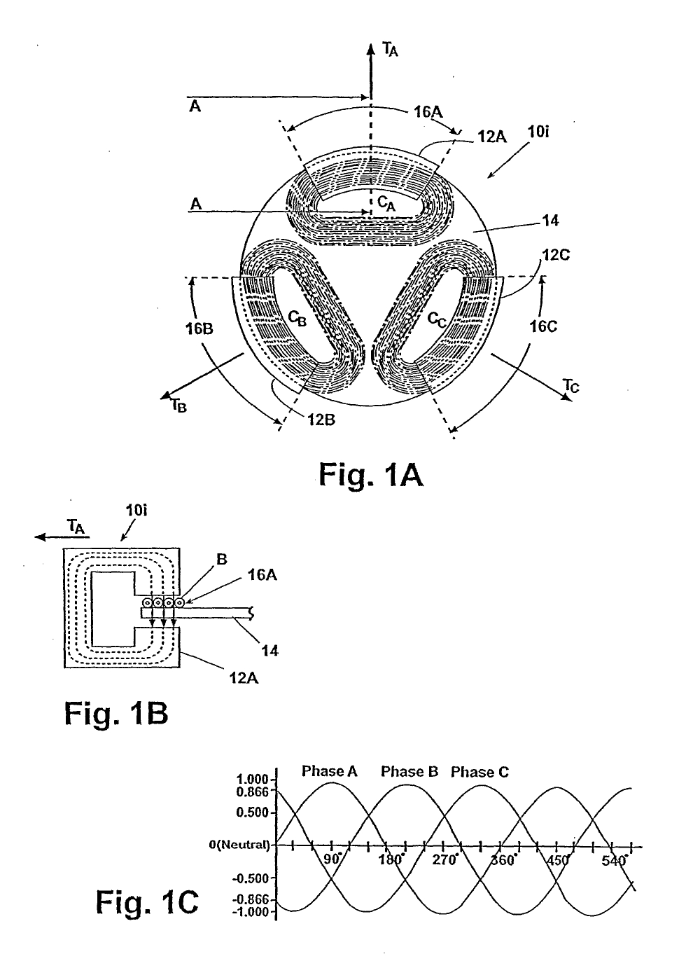

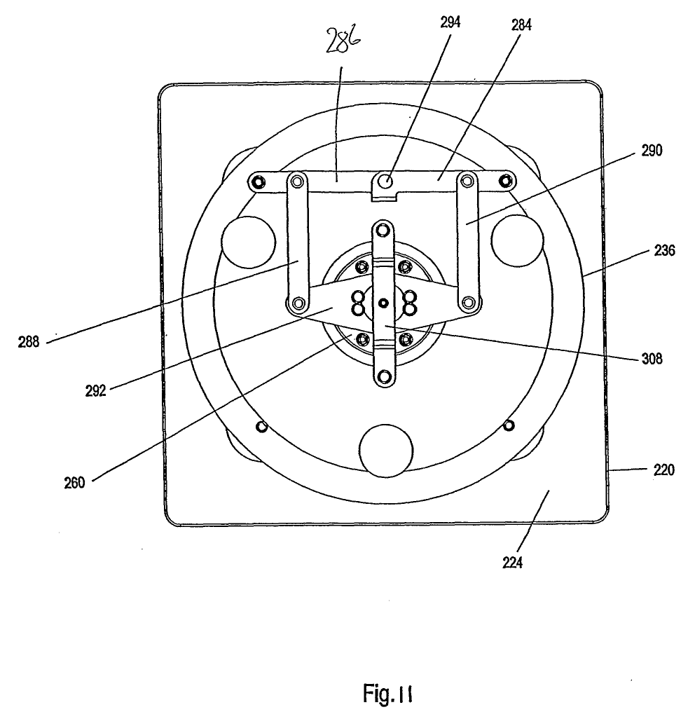

Embodiments of an oscillatory electric machine 200 in accordance with embodiments of this invention are depicted in FIGS. 9-20. The main components of the machine 200 are an electric motor 210 and a bearing support system for suspending an armature of the motor in an airgap. To assist in the understanding of the characteristics and functionality of the motor 210 detailed discussion will first be provided in relation to various embodiments of the electric motor with reference to FIGS. 1-8B.

FIGS. 1A and 1B depict a first embodiment of an electric motor 10 utilizing the same principles as the motor 210. The motor 10 comprises a magnetic field means in the form of three separate magnets 12A-12C (referred to in general as “magnets 12”) each producing a magnetic field having lines of flux B extending in the first direction perpendicularly into the page. A support in the form of disc 14 is provided that is capable of two-dimensional motion relative to the magnets 12 in the plane or the page. The disc 14 is provided with a minimum of two, and in this particular case three, electrically conductive paths in the form of conductor coils C_{A}, C_{B} and C_{C} (referred to in general as “conductive paths”; “coils”; or “paths” C).

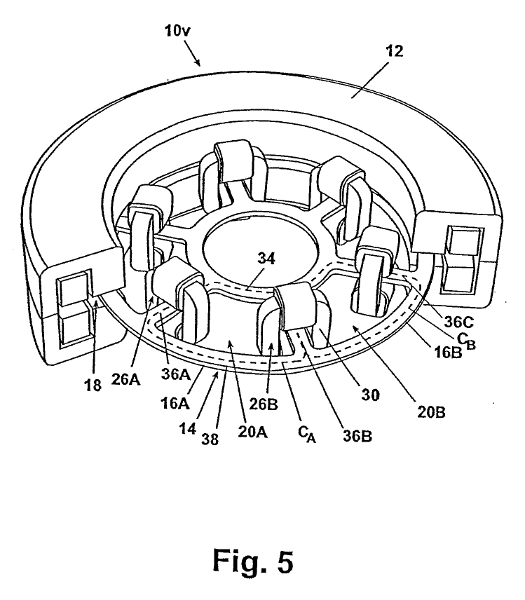

Throughout this specification and claims the expression “the disc (or support) is provided with electrically conductive paths” is to be construed as meaning that either the disc (support) has attached, fixed or otherwise coupled to it electrical conductors forming the paths, as shown for example in FIGS. 1-4; or, that the disc (support) is made of an electrically conductive material and does by itself provide or constitute the electrically conductive paths as shown for example in FIGS. 5-8B.

Consider the conductor path or coil C_{A} and its corresponding magnet 12A. The path C_{A} as a segment 16A that extends through the magnetic field B produced by the magnet 12A in a second direction that intersects the first direction (ie the direction of the lines of flux B) but it is not essential that the second direction is perpendicular to the first direction. If a current with a positive polarity is caused to flow in coil C_{A} say in the clockwise direction then the interaction of that current and magnetic field will produce a transverse thrust force T_{A} that acts on the disc 14 via the segment 16A. The direction of the thrust force T_{A} is provided by the right hand rule. Assuming the flux B is directed perpendicularly into the page the force T_{A} is directed in the upward direction in the plane of the page. If in a further arrangement the current is provided with a negative polarity then a left-hand rule is used to determine the direction of thrust forces.

The remaining coils or paths C_{B} and C_{C} likewise have corresponding segments 16B and 16C that extend in a direction perpendicular to the lines of magnetic flux of corresponding magnets 12B and 12C. Therefore, if electric currents are caused to flow in paths C_{B} and C_{C}, say in the clockwise direction, then similarly thrust forces T_{B} and T_{C} will be produced that act on the disc 14 via the respective segments 16B and 16C and in directions as dictated by the right hand rule. The segments 16A and 16B (and indeed in this instance also segment 16C) are located relative to each other so that their respective thrust forces T_{A} and T_{B} do not lie on the same axis or line. By having two thrust forces directed along different axes or lines, two-dimensional motions of the disc 14 can be achieved. Moreover, the path of motion of the disc 14 can be controlled by varying the magnitude and/or phase relationship of the electric currents flowing through the segments 16A-16C (referred to in general as “segments 16”).

When electric current is supplied to coil C_{A} only in the clockwise direction thrust force T_{A} is produced which causes the disc 14 to move in the direction of the thrust force. If coil C_{A} is now de-energized and coil C_{B} energized the disc 14 will move in a direction parallel to thrust force T_{B} which is angularly offset by 120° from the direction of thrust force T_{A}. If coil C_{B} is de-energized and coil C_{C} energized the disc 14 will move in the direction of corresponding thrust force T_{C} which is angularly offset by a further 120° from thrust force T_{B}. By repeating this switching process, it can be seen that the disc 14 can be caused to move in a triangular path in a plane, i.e. it can move with two-dimensional motion in a plane. A digital controller (not shown) can be used to sequentially provide DC currents to coils C_{A}-C_{C} at various switching rates and various amplitudes for control of the motion of the disc 14. Also, the path or motion can be modified by causing an overlap in currents supplied to the segments. For example, current can be caused to flow in both coils C_{A} and C_{B} simultaneously, perhaps also with modulated amplitudes.

In this embodiment, three separate coils C_{A}, C_{A}, and C_{C} are shown. However to produce two-dimensional motion in a plane a minimum of two coils, for example C_{A} and C_{B}, only is sufficient, provided the respective thrust forces T_{A} and T_{B} do not act along the same axis or line. Stated another way, what is required for a two-dimensional motion is that there is a minimum of two coils relatively disposed so that when their thrust forces are acting on the disc 14 they cannot produce a zero resultant thrust force on the disc (except when both the thrust forces themselves are zero).

Rather than the triangular motion described above, the disc 14 can be caused to move with a circular orbital motion by energizing the coils C_{A}, C_{B} and C_{C} with AC sinusoidal currents that are 120° out of phase with each other.

It is to be appreciated that the circular orbital motion is not a rotary motion about an axis perpendicular to the disc 14, i.e. the disc 14 does not act as a rotor in the conventional sense of the word. In the present embodiment, if each of the coils C_{A}, C_{B} and C_{C} were connected to different phases in the three phase sinusoidal AC current supply, of the type represented by FIG. 1C, the disc 14 would move in a circular orbital motion. This arises because the total resultant force, i.e. the combination of T_{A} T_{B} and T_{C} is of constant magnitude at all times. The difference in phase between the coils C_{A}, C_{B} and C_{C} leads to the direction of the resultant force simply rotating about the center of the disc 14. This is an angular linear force, not a torque. The frequency of the motion of disc 14 is synchronous with the frequency of the AC current to the coils C_{A}, C_{B} and C_{C}. Thus, the motion frequency of disc 14 can be varied by varying the frequency of the supply voltage/current. A non-circular orbit can be produced by providing coils C_{A}, C_{B} and C_{C} with currents that are other than 120° out of phase and/or of different amplitude.

In the embodiment shown in FIGS. 1A and 1B, the disc 14 is made of a material that is an electrical insulator and the coils C_{A}, C_{B} and C_{C} are wire coils that are fixed for example by glue or epoxy to the disc 14. The coils C_{A}, C_{B} and C_{C} have separate leads (not shown) that are coupled to a voltage supply (not shown). The magnets 12 have a C-shaped section as shown in FIG. 1B providing an airgap 18 through which lines of flux B extend. The segments 16 of each of the coils C are located in the airgap 18 of their corresponding magnets 12.

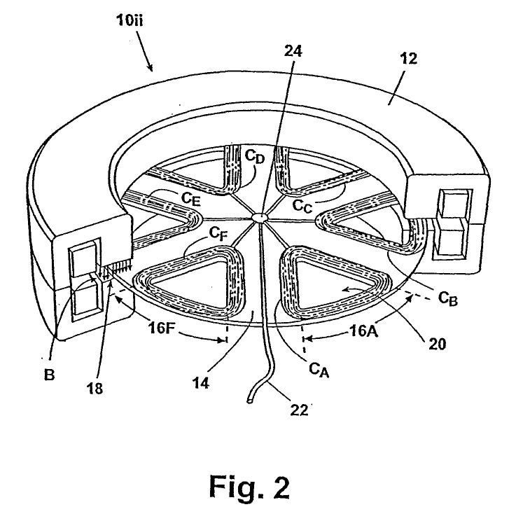

FIG. 2 illustrates an alternate form of the motor 10ᵢᵢ which differs from the embodiment shown in FIG. 1 by replacing the separate magnets 12A, 12B and 12C with a single magnet 12 in the form of a Cockcroft ring and in which the disc 14 is provided with six conductive paths or coils C_{A}-C_{F}. In order to reduce weight, the disc 14 is provided with six apertures or cut-outs 20 about which respective ones of conductive paths C extend. A multi-conductor cable 22 extends from a six phase power supply (not shown) to a central point 24 on the disc 14 where respective conductor pairs fan out to the coils C. The six phases required for the coils C_{A}-C_{F} can be obtained from a conventional star or delta three phase power supply by tapping off reverse polarities of each phase.

In the motor 10ᵢᵢ shown in FIG. 2, each conductive path or coil C has a segment 16 that is disposed in the airgap 18 of the magnet 12. As with the previous embodiment, when current is caused to flow through the segments 16, a transverse force is created due to the interaction between the current and the magnetic flux B, the transverse force is acting on the disc 14 via the respective segments 16. It will be recognized that many segments are located relative to each other so that their respective thrust forces are not parallel to each other in the plane of motion of the disc 14, i.e. their respective thrust forces do not lie along the same axis or line. For example the thrust force arising from current flowing through segment 16A lies on a different line to the thrust force arising from current flowing through segment 16F. The same holds for say segments 16A and 16C; and 16B and 16D. Consequently, the disc 14 is again able to move in a two-dimensional planar motion. The fact that thrust forces produced on diametrically-opposed segments are parallel does not negate the existence of other thrust forces that do not act along the same axis or line to enable the generation of the two-dimensional planar motion.

In order to avoid rubbing of components and reduce friction, the disc 14 may be supported on one or more resilient mounts, e.g. rubber mounts or springs so that it is not in physical contact with the magnet 12.

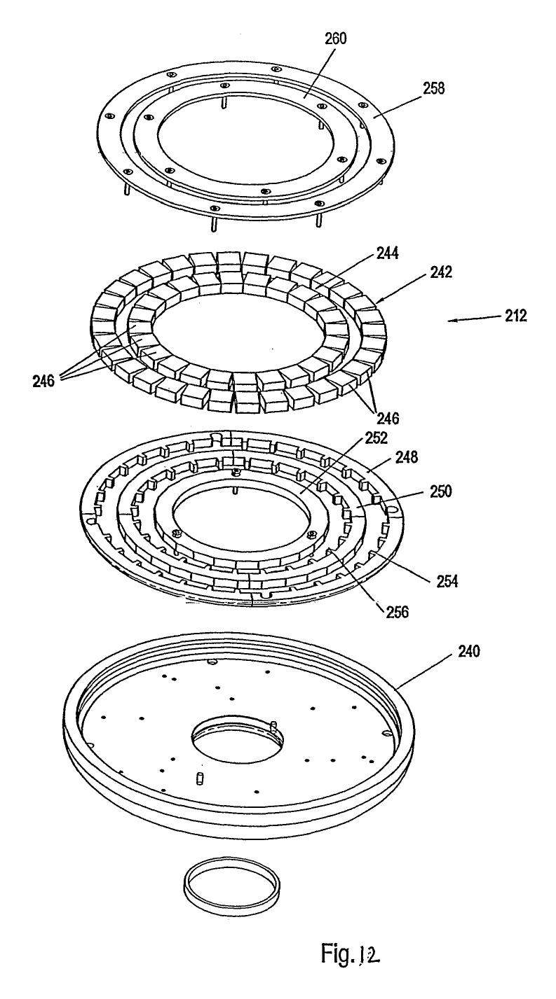

As will be explained in greater detail with reference to FIGS. 12-20, a platform can be attached to the disc 14 for imparting the motion of the disc 14 to another object supported on the platform, such as a grinding head, or a biological sample. Unlike most conventional vibrators, agitators or shakers, the frequency of the orbital motion can be changed at will by varying the frequency of the AC supply to the coils C. Further, the actual path and/or diameter of motion can be varied from a circular orbit to any desired shape by varying the phase and/or amplitude relationship between the currents in the coils C while the machine is in motion.

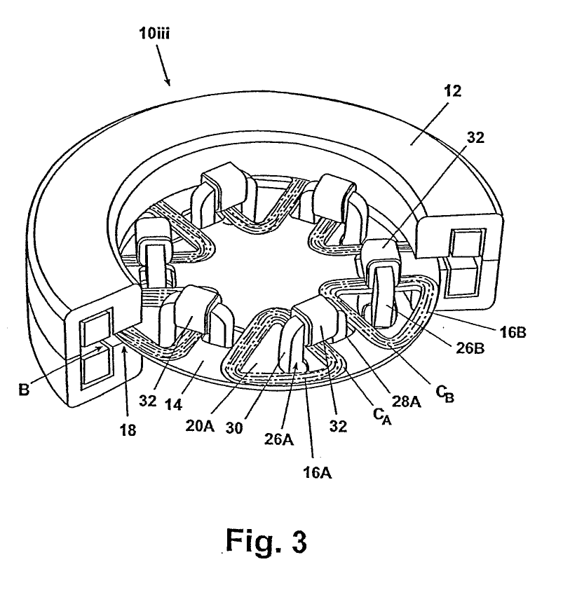

A further embodiment of the electric motor 10ᵢᵢᵢ is shown in FIG. 3. In the electric motor 10ᵢᵢᵢ instead of each coil C being physically connected by a conductor to a current supply through multi-connector cable 22, current for each coil C is produced by electromagnetic induction using transformers 26A-26E (referred to in general as “transformers 26”). Further, the conductive paths (i.e. coils C) are now multi-turn closed loops. The disc 14 includes in addition to the apertures 20, a plurality of secondary apertures 28A-28F (hereinafter referred as “secondary apertures 28”), one secondary aperture 28 being located adjacent a corresponding primary aperture 20 with the apertures 20 and 28 being separated by a portion of the coils C extending about the particular primary aperture 20.

Each transformer 26 has a core 30 and a primary winding 32. The primary winding 32 may be in the form of two physically separated though electrically connected coils located one above and one below the plane of the disc 14. The core 30 of each transformer links with one of the coils C so that coil C acts as secondary windings. This interlinking is achieved by virtue of the core 30 looping through adjacent pairs of apertures 20 and 28.

It will be appreciated that a current flowing through the primary winding 32 of a transformer 26 will induce the current to flow about the linked coil C. The apertures 20 and 28, and core 30 are relatively dimensioned to ensure that the disc 14 does not impact or contact the core 30 as it moves in its two-dimensional planar motion. The transformers 26 are supported separately from the disc 14 and thus do not add any inertial effects to the motion of the disc 14. By using induction to cause currents to flow through the coils C the need to have a physical cable or connection as exemplified by multiconductor cable 22 the motor 10ᵢᵢ is eliminated. This is seen as being particularly advantageous as cables or other connectors may break due to fatigue caused by motion of the disc 14 and also add weight and thus inertia to the disc 14.

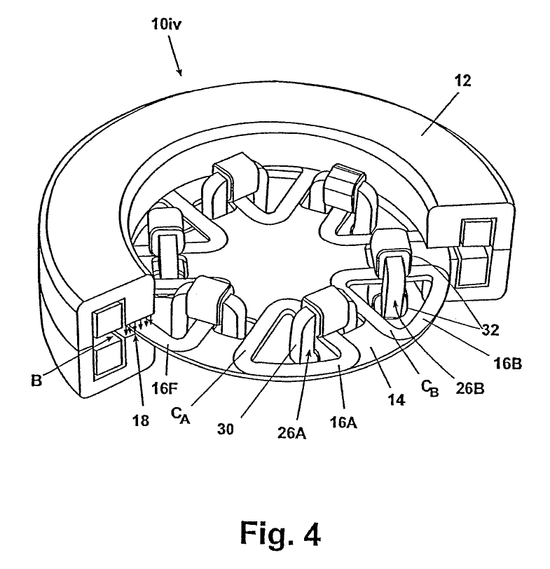

FIG. 4 illustrates a further embodiment of the electric motor 10ᵢᵥ. This motor differs from motor 10ᵢᵢᵢ by forming the respective conductive paths C with a single turn closed loop conductor rather than having multiturn coils as previously illustrated. Replacing a multi-turn wire coil with a single solid loop has no adverse effects. The single solid loop behaves the same as the multi-turn coil with the same total cross-sectional area, where the current in the single loop equals the current in each turn of the coil multiplied by the number of turns, thereby giving the same resultant thrust force. Again, as with the previous embodiments, the motion of the disc 14 can be controlled by the phase and/or magnitude relationship of electric currents flowing through the segments 16 of each conductive path, i.e. conductive loop C.

FIG. 5 illustrates yet a further embodiment of the electric motor 10ᵥ. This is a most remarkable embodiment as the conductive paths C are electrically connected together.

In the motor 10ᵥ, the disc 14 is now in the form of a wheel having a central portion in the form of a hub 34, a plurality of spokes 36 extending radially outwardly from the hub 34 and an outer peripheral rim 38 joining the spokes 36. Apertures 20 similar to those of the previous embodiments are now formed between adjacent spokes 36 and the sectors of the hub 34 and rim 38 between the adjacent spokes 36. The disc 14 is made of an electrically conductive and most preferably non-magnetic material such as aluminum. The current paths are constituted by the parts of the disc 14 surrounding or bounding an aperture 20. For example, conductive path C_{A} (shown in phantom) comprises the spokes 36A and 36B and the sectors of the hub 34 and 38 between those two spokes. Conductive path C_{B} is constituted by spokes 36B and 36C and the sectors of the hub 34 and 38 between those two spokes. The sector of the rim 38 between adjacent spokes form the segment 16 for the conductive path containing those spokes. It is apparent that adjacent conductive paths C share a common spoke, (i.e. have a common run or leg). Each transformer 26 links with adjacent apertures 20 and has, passing through its core 30 one of the spokes 36. Consider for the moment transformer 26B. The core of this transformer passes through adjacent apertures 20A and 20B with the spoke 36B extending transversely through the core 30 of transformer 26B. The current induced into spoke 36B by the transformer 26B is divided between current paths C_{B} and C_{A}. Thus the transformer 26B, when energized, induces a current to flow through both paths C_{A} and C_{B}. In like fashion, each of the transformers 26 can induce the current to flow in respective adjacent conductive paths C. The state of the transformers will determine the current division between adjacent conductive paths C. Hence, the sectors of the rim 38 between adjacent spokes 36 and the currents flowing through them act in substance the same as the segments 16 in the motors 10ᵢ-10ᵢᵥ.

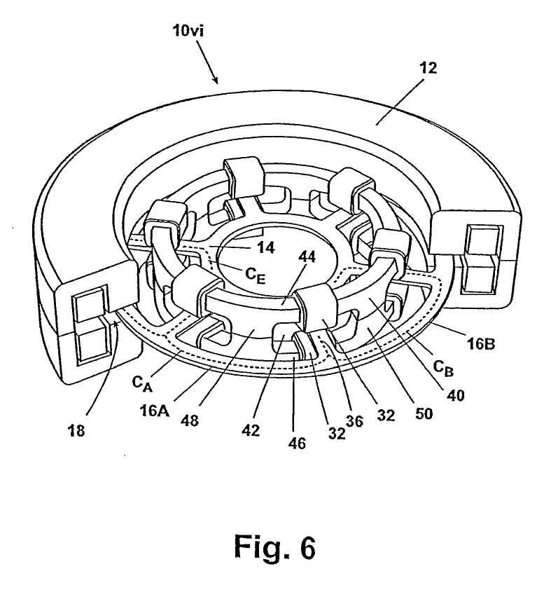

FIG. 6 illustrates a further embodiment of the electric motor 10ᵥᵢ. This motor differs from electric motor 10ᵥ by replacing the separate transformers 26 with a multi-phase toroid shaped transformer dubbed a “transoid” 40. The transoid 40 can be viewed as a ring of magnetically permeable material formed with a number of windows 42 and arranged so that separate conductive spokes 36 pass through individual different windows 42. Each window 42 is bound by opposed branches 44 and 46 that extend in the plane of the disc 14 and opposed legs 48 and 50 that extend perpendicularly to and join the opposed branches 44 and 46. Primary windings 32 are placed on each of the opposed branches 44 and 46 for every window 42. (Although it should be understood that primary winding can be placed about any part in the window i.e., about any one or more of branches 44 and 46 and legs 48 and 50 with one or more primary windings being utilized in various embodiments). Primary windings 32 are coupled to a six phase current supply in a manner so that the windings 32 for each window 42 are coupled to a different phase. Current flowing through the primary windings 32 sets up lines of magnetic flux circulating about the windows 42. This flux in turn induces the current to flow in the spoke 36 passing through that window 42 and the conductive path C to which that spoke 36 relates. It will be recognized that the majority of the flux generated about adjacent windows 42 will circulate through the common adjacent leg 48.

In comparison with the electric motor 10v shown in FIG. 5, the use of the transoid 40 makes more efficient use of its core because flux is shared from one or more primary coils. That is, magnetic flux induced by currents in primary coils about adjacent windows 42 can be shared through the common leg 48. Indeed more distant primary coils can contribute to the flux in that leg.

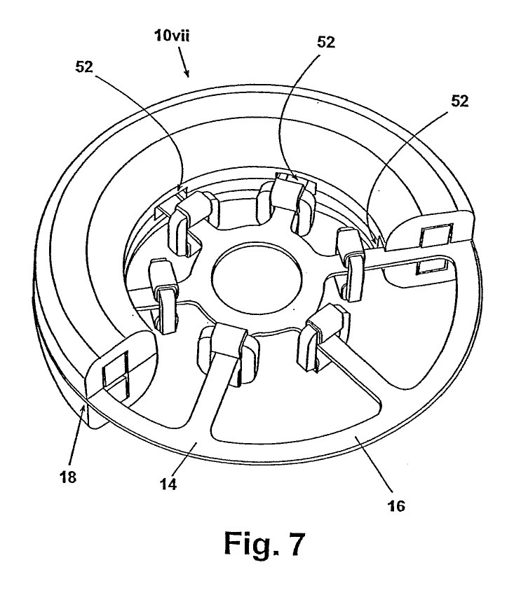

A further embodiment of electric motor 10ᵥᵢᵢ is shown in FIG. 7. This embodiment differs from the motor 10ᵥ shown in FIG. 5 in the configuration of the Cockcroft ring 12. In this embodiment, the airgap 18 of the Cockcroft ring is on the outer circumferential surface of the Cockcroft ring rather than on the inside surface as shown in FIG. 5. Additionally, a plurality of radially extending slots 52 are formed in the Cockcroft ring 12 through which the spokes 36 can pass. The slots 52 must be sufficiently wide to not inhibit the motion of the disc 14.

In the embodiments of the electric motor 10ᵢᵢ-10ᵥᵢᵢ there are six segments 16 through which current flows to produce respective transverse forces that act on the disc 14. However, this can be increased to any number. Conveniently however the number of segments 16 will be related to the number of different phases available from a power supply used for driving the motor 10. For example, the motor 10 can be provided with twelve segments 16 through which current can flow by use of a twelve-phase supply. In this instance, therefore, transformers are used to induce currents to flow in each segments, there will be required either twelve separate transformers 26 as shown in FIGS. 4, 5, and 7 or alternately a twelve window transoid 40.

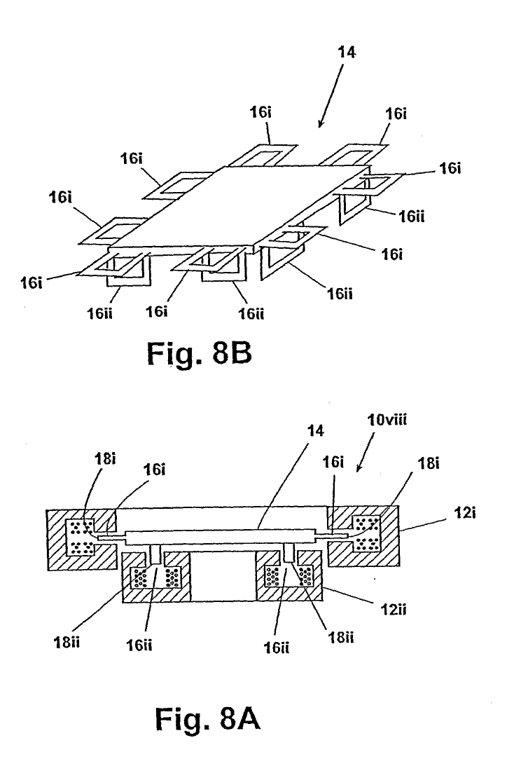

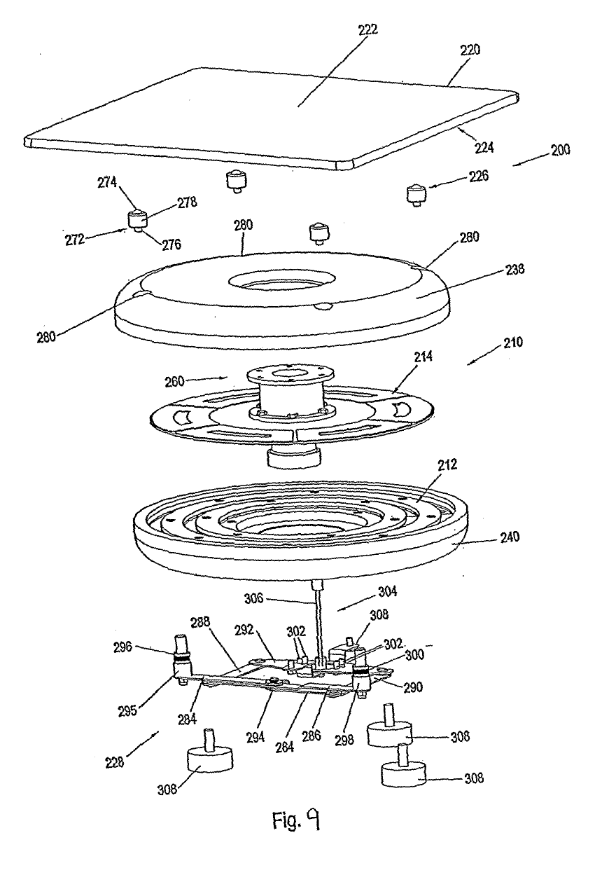

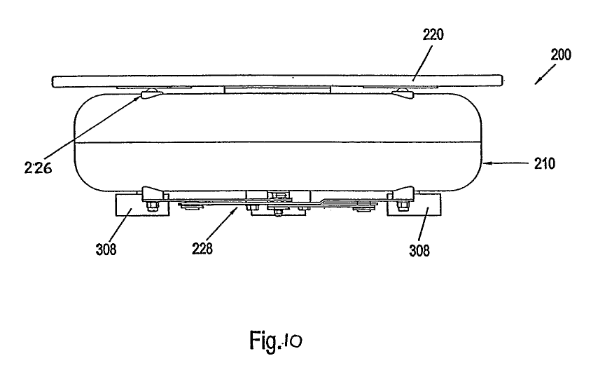

In the afore-described embodiments, the motion of the support 14 is a two-dimensional motion in one plane. However, motion in a second plane or more nonparallel planes can also be easily achieved by the addition and/or location of further segments 16 in the second or additional planes and, further means for producing magnetic fields perpendicular to the currents flowing through those additional segments. An example of this is shown in the motor 10ᵥᵢᵢᵢ in FIGS. 8A and 8B in which the support 14 has one set of segments 16ᵢ and a first plane (coincident with the plane of the support 14) and a second set of segments 16ᵢᵢ that extend in a plane perpendicular to the plane of the support 14. The motor 10ᵥᵢᵢᵢ has first magnet 12ᵢ having an airgap 18ᵢ in which the segments 16ᵢ reside, and a second magnet 12ᵢᵢ having an airgap 18ᵢᵢ in which the second set of segments 16ᵢᵢ reside. Thus, in this embodiment, the support 14 can move with a combined two-dimensional motion in the plane of the support 14 and an up and down motion in a second plane perpendicular to the plane of the support 14. Thus, in effect, in this embodiment, the support 14 can float in space by action of the thrust forces generated by the interaction of the current flowing through segments 16ᵢᵢ and the magnetic field in the airgap of the magnet 12ᵢᵢ. It is also apparent from the previous motor embodiments 10ᵢ-10ᵥᵢᵢ that the segments 16ᵢ and 16ᵢᵢ of the motor 10ᵥᵢᵢᵢ can be individually supplied with electrical currents. In such instances the motion of the support 14 in the second plane is not just limited to a perpendicular up and down movement but can include motion with two degrees of freedom. As is apparent from FIG. 8B the support 14 need not be circular in shape but can be square (as in FIG. 8B) or any other required/desired shape. For the sake of clarity the means for supplying current to the segments 16ᵢ, 16ᵢᵢ have not been shown. The currents may be provided by direct electrical connection to a current source as in the embodiments 10ᵢ and 10ᵢᵢ or via induction as in embodiments 10ᵢᵢᵢ to 10_{.sub.vii}.

FIGS. 9-14 depict an embodiment of an oscillatory electric machine 200 that incorporates yet a further alternate embodiment of an electric motor 210. As explained in greater detail below, the electric motor 210 differs in essence from the motors 10-10ᵥᵢᵢᵢ by the provision of a magnet assembly 212 which provides two concentric airgaps 218a and 218b (referred to in general as “airgaps 218”) and by forming an armature disc 214 (hereinafter referred to as “armature 214”) having a plurality of electrically conducting paths C_{A}-C_{F} where each connective path C has two current carrying segments 216₁ᵢ and 216₂ᵢ where i represents the nominal coil “number” A-F one in each of the airgaps 218a and 218b respectively. The oscillatory machine 200 also comprises a platform 220 having a load carrying surface 222 and an opposite undersurface 224 that is coupled to the armature 214. The armature 214 is suspended in the airgap 218 by a bearing support system 226 that is located between the platform 220 and the armature 214. The oscillatory machine 200 also includes a restraint system 228 that is coupled to the electric motor 210 and the support 220 to restrain twisting motion of the support 220.

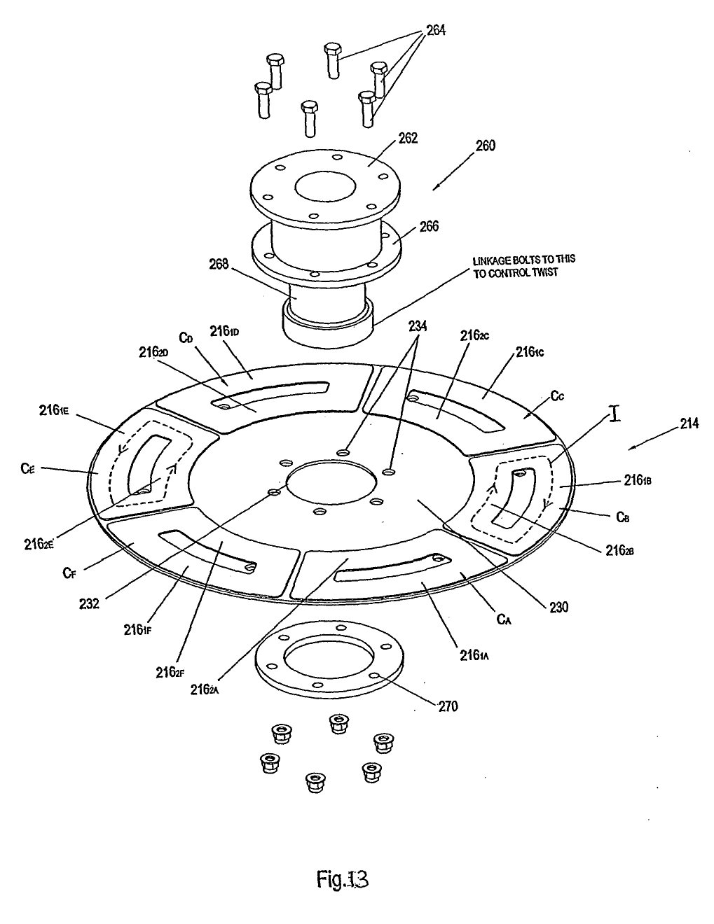

Referring to FIG. 13, the armature 214 is made from a circular disc 230 of non-conductive rigid material such as a polymer compound or fiberglass where the conductive paths C are formed by flat substantially rectangular wire coils fixed about the periphery of the disc. Forming the paths C as rectangular coils produces the two current carrying segments 216ᵢᵢ and 216₂ᵤ each of which extend with a circumferential aspect to the disc 230. It will further be appreciated that a current circulating within any particular path moves in opposite linear directions in each of the segments 216₁ᵢ and 216₂ᵢ. For example consider current I circulating in a clockwise direction in path C_{B}. The current in segment 216_{1b} flows in an opposite linear direction to the current in segment 216_{2b}. If desired a second set of conductive paths may be attached to an underside of the disc 230. The armature 214 is provided with a central hole 232 with a plurality of smaller bolt holes 234 formed thereabout.

Referring to FIGS. 9, 12 and 14 the motor 210 further comprises a donut-shaped body 236 that is radially split into identical upper and lower shells 238 and 240 respectively. The body 236 houses the magnet assembly 212. The magnet assembly 212 comprises in each of the shells 238 and 240 an outer ring 242 and inner ring 244 of permanent magnets 246. The magnets 246 are retained in their respective rings 242 and 244 by an outer locating band 248, an intermediate locating band 250 and an inner locating band 252. The outer band 248 and intermediate band 250 are provided with a plurality of inwardly projecting keys 254 and 256 respectively. The ring of magnets 242 is held between the bands 248 and 250 with the keys 254 located between adjacent magnets 246. The inner ring of magnets 244 is located between the intermediate band 250 and inner band 252 with respective keys 256 located between adjacent magnets 246. The outer, intermediate and inner bands 248, 250 and 252 are made from a non-magnetic material and preferably a plastics material. The inner ring 252 is fastened by screws or bolts to the lower shell 240.

An outer annular pole piece 258 made from a magnetizable material overlies the outer ring of magnets 242 and is bolted to the shell 240. Similarly, an inner annular pole piece 260 overlies the inner ring of magnets 244 and is bolted to the shell 240.

Each of the magnets 246 in the outer ring 242 is arranged with the same polar orientation. The magnets 246 in the inner ring 244 are also each orientated with the same polar orientation but opposite to the orientation of the magnets in the outer ring 242. The magnet assembly within the upper shell 238 is identical to that of the lower shell thereby producing the first airgap 218a extending between the outer ring of magnets 242 in the upper and lower shells 238 and 240; and the second annular airgap 218b extending between the inner ring of magnets 244 in the upper and lower shells 238 and 240. The airgaps 218a and 218b are configured to substantially align with the current carrying segments 216₁ᵢ and 216₂ᵢ respectively. Due to the opposite polar orientation of the magnets within the inner and outer rings 242 and 244 the direction of magnetic flux B in the respective airgaps 218a and 218b is reversed. Moreover, the magnetic flux B forms a closed loop circulating through the magnet rings 242 and 244 and intervening portions of the upper and lower shells 238 and 240. As the current flowing through the segments 216₁ᵢ and 216₂ᵢ of any coil C is in opposite linear directions the thrust force created by the interaction of current flowing through each of the segments of any particular path C and the magnetic flux B act in the same direction on the portion of the armature 214 to which that particular path C is attached.

The platform 220 is coupled to the armature 214 by an axially extending hub 260. The hub 260 has a first mounting flange 262 at one end that is fastened against the undersurface 224 of the platform 220 by a plurality of bolts 264. The hub 260 includes a second flange 266 and a reduced diameter portion 268. The reduced diameter portion 268 passes through the central hole 232 in the armature 214 with the flange 266 placed against an upper surface of the disc 230. A mounting ring 270 is passed over the reduced diameter portion 268 on the opposite side of the disc 230 so that the armature 214 is effectively clamped between the flange 266 and the ring 270.

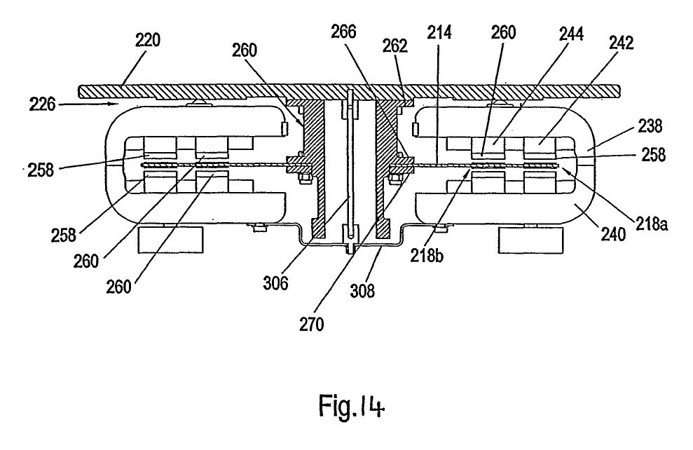

Reverting to FIG. 9, one form of the bearing support system 226 comprises at least three (in this instance four) ball roller assemblies 272. Each ball roller assembly 272 comprises a ball roller 274 and a roller support surface 276 on which the ball 274 rolls. In this particular embodiment, the surface 276 is a lower surface of a cage or cup 278 which retains the ball 274. The surface 276 is concavely curved to seat the ball 274 allowing the ball 274 to roll in any direction (ie about any axis) within the cage 278. Each of the assemblies 272 sits in a corresponding recess 280 formed on the upper shell 238 of the motor body 236. The roller surfaces 276 are all disposed within a Common plane that is parallel to the plane of the platform 220 and the plane of the armature 214. It should be appreciated, particularly from FIG. 14, that the bearing support system 226 effectively suspends the armature 214 within the airgap 218 via the support 220 and the hub 260. The bearing support system 226 enables near frictionless two-dimensional motion of the platform 220 in a-plane (in x/y directions). The motion of the platform 220 is without any motion in the vertical plane, ie without any z motion.

The restraint system 228 restrains twisting motion of the support 220. The restraint system is coupled to the platform 220 and the motor body 236 and, in this embodiment is in the form of a plurality of pivotally coupled arms. With reference to FIGS. 9 and 11, the arms are arranged in a parallelogram type configuration and comprises a first arm 284, a second arm 286, a third arm 288, a fourth arm 290 and a fifth arm 292. The first and second arms 284 and 286 are coupled together about their mid-point by a pivot pin or bolt 294. Further, the arm 284 crosses over the arm 286 in the region of the pivot pin 294. One end 295 of the first arm 284 is resiliently coupled to the lower shell 240 via a rubber mounting block 296. Similarly, one end 298 of the second arm 286 is resiliently coupled to the lower shell 240 via a rubber mounting block 300. The arm 288 is pivotally coupled at opposite ends to arms 286 and 292, and arm 290 is pivotally coupled at opposite ends to the arm 284 and 292. The arm 292 is in turn rigidly coupled to the reduced diameter portion 268 of the hub 260 via bolts 302. The restraint system 282 allows the platform 220 and the armature 214 to move in a plane while restraining twisting motion which could rise for example if a corner of the platform 220 is heavily loaded or restrained.

A self-centering system 304 acts to return the platform 220 to a central position relative to the motor 210 when the machine 200 is not energized. The self-centering system comprises a rod 306 which is resiliently coupled at opposite ends to the undersurface 224 of the platform 220 and to the lower shell 240 via a bracket 308. The rod 306 extends axially through the hub 260. Due to its resilient mounting the bar 306 is continuously biased to a vertical position within the hub 206. When the oscillatory machine 200 is in operation with the platform 220 moving in a plane, the bar 306 is displaced from its vertical position (although at times may travel through this position). When the machine 200 is de-energized, the only force acting on the platform 220, other than gravity, will be that applied by the self centering system 304 which will return the bar 306 to its vertical position and thus the platform 220 to a central position relative to the machine 200.

A plurality of feet 308 is attached to an underside of the lower shell 240 and can be adjusted to enable leveling of the platform 220.

The principle of operation of the motor 210 in the machine 200 is identical to the motors 10 described in relation to the embodiments depicted in FIGS. 1-8B. The interaction of current flowing through the segments 216 and the magnetic flux extending through the airgaps 218 create thrust forces which act on the armature 214 to move it in two dimensions in a single plane. This motion is transferred to the support or platform 220 via the hub 260. The bearing support system 226 effectively suspends the armature 214 within the airgap 218 and provides near frictionless motion of the platform 220. In this particular embodiment, the platform 220 moves without any vertical motion.

The machine 200 is particularly well suited for the shaking of biological products such as blood and blood plasma that has benefits in terms of extending their viability. However the oscillatory machine 200 may be used for many other purposes as described hereinbefore. By appropriate control of the currents flowing through respective segments 216, the motion of the platform 220 can be precisely controlled. For example, but without limitation, the platform 220 may be controlled to move in a simple circular orbital motion, in the motion of a FIG. 8, or following the path of a star.

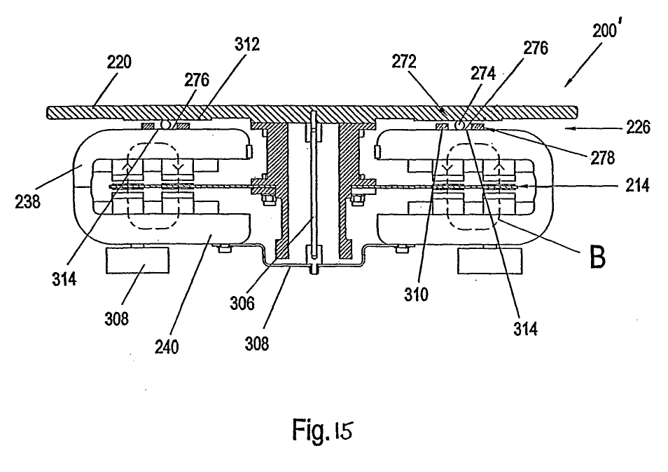

FIG. 15 depicts a further embodiment of the oscillatory machine 200′ which differs from the machine 200 only in the form of the bearing support system 226 and the profile of the undersurface 224 of the platform 220. In this embodiment, the cage 278 is not in the form of a cup but rather a ring 310 having an inner diameter several times greater the diameter of the ball roller 274. Further, the undersurface 224 is provided with an integrally formed pad 312 that extends over the ring 310. Here, the ball 274 is free to roll anywhere within the confines of the ring 310 and bound between the pad 312 and a surface portion 314 of the upper shell disposed within the ring 310. The surface 314 in this embodiment constitutes the roll support surface 276. The roll support surface 276 is planar and parallel to the plane of the platform 220 and the armature 214. Accordingly the platform 220 again moves in two dimensions in a single plane.

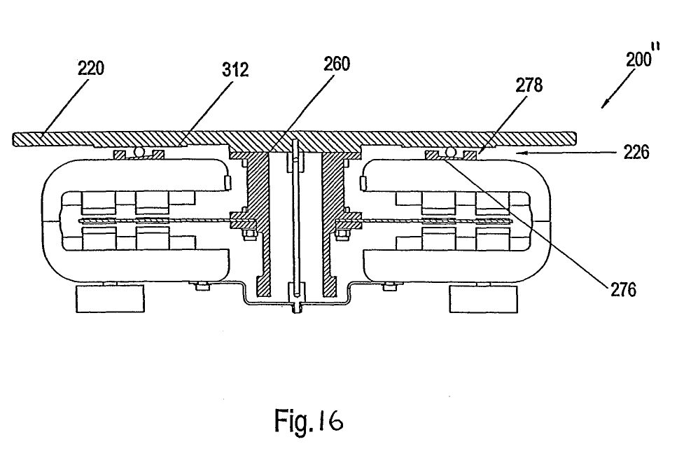

FIG. 16 depicts a further form of the oscillatory machine 200″ with a modified form of bearing support system 226 that in this instance provides controlled limited vertical (Z) motion of the platform 220. This is achieved by forming the cage 278 with a support surface 276 that is sloping relative to the plane of the platform 220. Thus now, the ball rollers 274 can roll up and down the inclined support surface 276 introducing limited up and down motion of the platform 220. The degree of up and down motion is determined by the inclination of the surfaces 276. It should be noted however that appropriate dimensioning of the airgap 218 is required to ensure that the up and down motion of the platform 220 does not result in the armature 214 contacting the pole pieces 258.

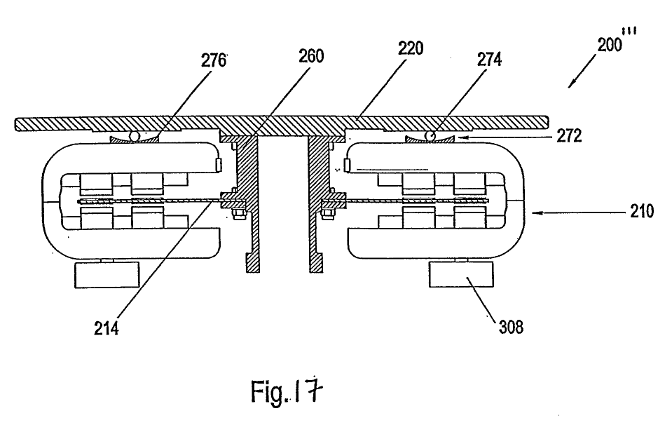

FIG. 17 depicts a further form of the oscillatory machine 200′″ with yet another embodiment of the bearing support system 226. Here, the cage 276 comprises a shallow cup or dish with a concavely curved roll support surface 276 and of a diameter several times that of the ball 274. This again provides limited vertical up and down motion. In this embodiment, the concavely curved support surface 276 together with the ball 276 also acts as a self-centering system returning the platform 220 to a central position relative to the motor 210 when the motor is not energized. Accordingly in this embodiment, the self-centering system 304 depicted in the embodiment shown in FIG. 9 is not required.

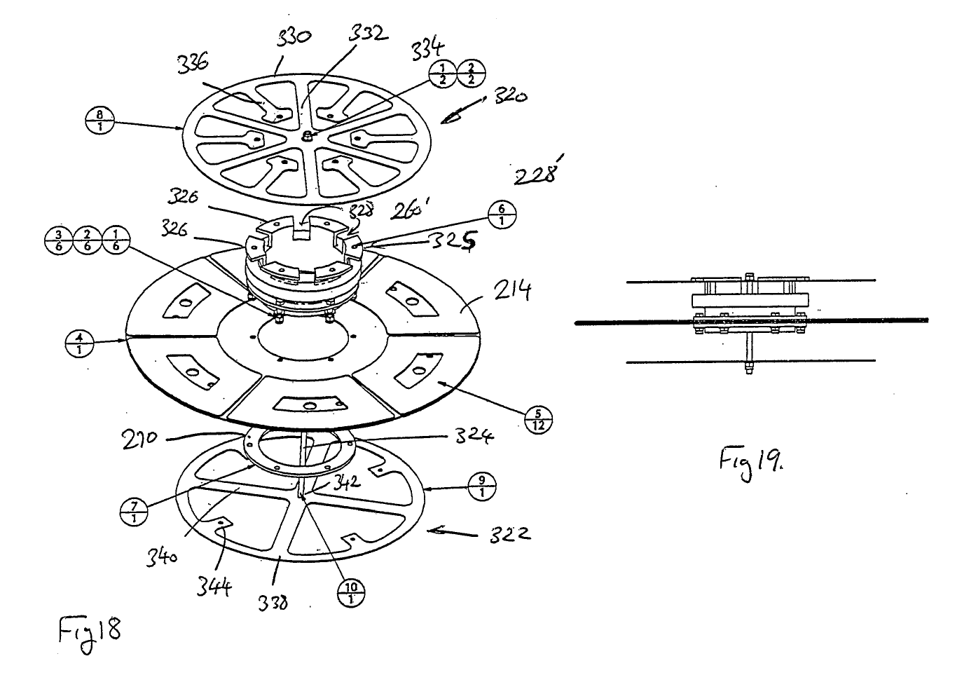

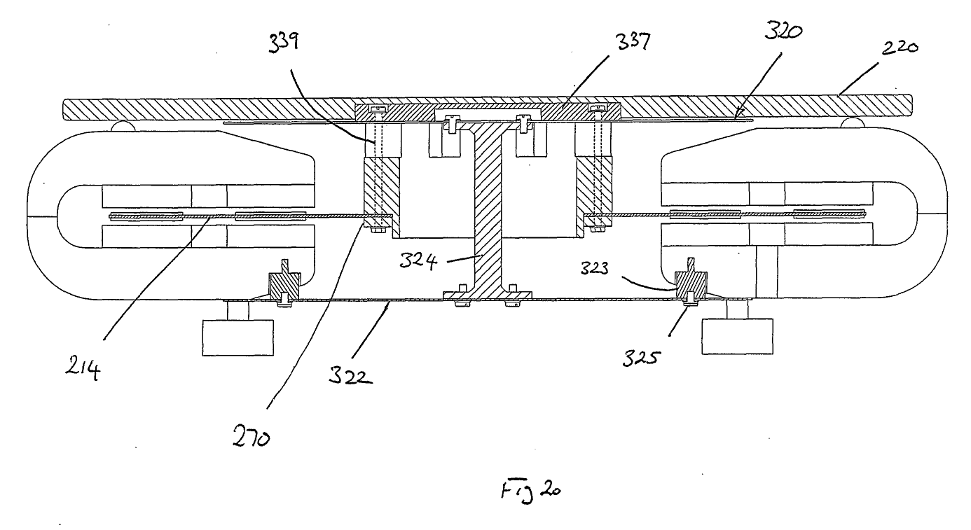

FIGS. 18 and 19 depict an alternate form of restraint system 228′, which may more accurately be considered as a spring system. The system 228′ does away with the parallelogram arrangement of arms 284, 286, 288, 290 and 292 shown in FIGS. 9 and 11 and replaces them with a first planar spring or upper spider 320, a second planar spring or lower spider 322 and a connecting rod 324. Additionally, in comparison with the restraint system 228 of FIG. 9, the system 228′ is provided with a differently configured hub 260′. The hub 260′ is provided with a castellated upper end 325 with a plurality of flanges 326 that are separated by recesses 328. Additionally, the hub 260′ does not include the reduced diameter portion 268 of the hub 260.

Each of the spiders 320,322 is made of a resilient material such as a spring steel or fibreglass. As a result of the material and their configuration, the spiders act as and can be considered to be springs. The upper spider 320 is in the form of a wheel having an endless outer circumferential strip 330 and a plurality of evenly spaced radial spokes 332 that are coupled together in a central web 334. Extending radially inward between each pair of adjacent spokes 332 is a connecting arm 336. The radially inner end of each arm 336 stops short of and is not connected to the central web 334.

The lower web 322 is also in the form of a wheel having an endless an outer circumferential strip 338 and a plurality of evenly spaced apart spokes 340 that join in a central web 342. Evenly spaced between each pair of adjcent spokes 340 is a radially inwardly projecting connecting tab 344.

With reference to FIG. 20, the lower spider 322 is attached to the underside of the lower shell 240 by way of resilient mounts 323 that are seated in recesses formed in the lower shell 240. Mechanical fasteners 325 pass through holes formed in the connecting tabs 344 and into the mounts 323. The upper spider 320 is seated in the hub 2601 with the spokes 332 located within respective recesses 328 and the free ends of the arms 336 located in alignment with and below respective flanges 326 on the hub 260′. Opposite ends of the spindle 324 are attached to the webs 334 and 342 of the upper and lower spiders respectively by mechanical fasteners, such as screws.

The restraint system 228′ both restrains twisting motion of the platform 220 as well as providing bias to self centre the platform. The planar motion of the armature 214 and platforms is accommodated by the restraint system 228′ by flexing of the spokes 332 and 340 together with tilting of the connecting rod 324. For example, with reference to FIG. 20, if the armature 214 (and thus the platform 220) were moved linearly to the left the upper spider 320 would move with the platform. As the rod 324 is of a fixed length, this motion is permitted by the spokes 332 and web 334 flexing generally in a downward direction and the spokes 340 and web 342 of the lower spider 322 flexing generally in an upward direction together with a tilting to the left of the connecting rod 324.

The restrain 228′ may be considered as a spring mass system which stores energy when displaced from a steady state position. This system can be tuned to the speed and load of the machine 200 to operate in the resonance range of the machine. Tuning can be performed by forming the spiders 320 and 322 of different thicknesses or materials so that the system can have a different effective spring constant. Initial tests have shown that by tuning the spiders the power required to run the machine in a resonance range is reduced by a factor of 3-5 times. In comparison with the restraint system 228 shown in FIG. 11, the use of the spiders in restraint system 228′ has been noted in one test to reduce current draw on the machine from 5 Amps to 1 Amp. Different sized spiders could therefore be provided for specific applications, if the frequency and application at hand was to be fixed within a certain range.

The oscillatory machine 200 may incorporate any of the electric motors 10-10ᵥᵢᵢᵢ described hereinbefore and illustrated in FIGS. 1-11. Although motors of the type where the coils are directly fed with current (eg as shown in FIGS. 1 and 2) rather than by induction are preferred when it is desired to make the machine 200 as compact as possible.

From the above description it will be apparent that embodiments of the present invention have numerous benefits over traditional machines used for generating vibratory or orbital motion. Clearly, as the motion of the disc 14 is non-rotational, there is no need for bearings, lip seals, gearboxes, eccentric weights or cranks. In addition, the inertial aspects of rotation, such as a time to accelerate to speed and gyroscopic effects are irrelevant. In the embodiments of the machine 10ᵢᵢ-10ᵥᵢᵢ induction is used to cause current to flow in the segments 16 and thus commutators, brushes, and flexible electric cables arc not required. It will also be apparent that the only moving part of the machine 10 is either the support 14 or the magnetic field means 12. When it is the support 14 itself that carries the electric current as shown in embodiments 10ᵥ-10ᵥᵢᵢ this support 14 may be made from one piece only say by punching or by casting. In these embodiments the disc 14 must be made from an electrically conductive material and most preferably a non-magnetic material such as aluminum, copper or stainless steel. When the machine 10 is used to generate an orbital motion from imparting to another object (for example a grinding head) there can be a direct mechanical coupling by use of bolts or screws.

The motor 10 is a force driven machine and the force it delivers is essentially unaltered by its movement. There is a small degree of back EMF evident, however the tests indicate that this is almost negligible, especially when compared with conventional rotating motors. As such, the motor 10 is able to deliver full force regardless of whether the disc 14 is moving or not. For this reason, current drawn by the motor 10 is relatively unaffected by the motion of the disc 14. This enables the motion of the disc 14 to be resisted or even stalled with negligible increase in current draw and therefore negligible increase in heat build-up.

In the conventional mechanical orbital or vibratory machines, the orbital or vibratory motion is usually fixed with no variation possible without stopping the machine to make suitable adjustments. With the motor 10ᵢ the orbit diameter is proportional to the force applied, which in turn is proportional to the currents supplied. Therefore the orbit diameter can be controlled by varying the supply voltage that regulates the current in the segment 16. This results in a linear control with instant response available, independent of any other variable. As previously mentioned, the orbit frequency is synchronous with the frequency of the supply voltage, so that orbit frequency can be varied by varying the supply frequency. The motor 10 also allows one to avoid undesirable harmonics. A common problem with conventional out of balance drive systems is that as the motor builds up speed it can pass through frequency bands coinciding with the actual harmonic frequencies of various attached mechanisms that can then lead to uncontrolled resonance that can cause damage to the machine or parts thereof. The disc 14 however is able to start at any desired frequency and does not need to ramp up from zero frequency to a required frequency. In this way any undesired harmonics can be avoided. Particularly, the motor 10 can be started at the required frequency with a zero voltage (and hence zero orbit diameter) and then the voltage supply can be increased until the desired orbit diameter is reached.

If no control over the orbit diameter or frequency is required, the motor 10 can be connected straight to a mains supply so that the frequency will be fixed to the mains frequency. Nevertheless, full control is not difficult or costly to achieve. Existing motor controllers which utilize relatively simple electronics with low computing requirements can be adapted to suit the motor 10. Because voltage supplies can be controlled electronically, the motor 10 can be computer driven. This enables preset software to be programmed and for safety features to be built into the supply controller allowing its operation to be reprogrammed at any time. The addition of feedback sensors can allow various automatic features such as collision protection. When the disc 14 is mounted on rubber supports, it can be considered as a spring-mass system. As such, it will have a harmonic or resonance frequency at which very little energy is required to maintain orbital motion at that frequency. If the machine 10 is only required to run at one frequency, the stiffness of the rubber supports can be chosen such that resonance coincides with this frequency to reduce the power losses and hence improve the machines efficiency.

While the description of the preferred embodiments mainly describes the disc 14 as moving in an orbit, depending on the capabilities of the controller for the supply, i.e. the ability to vary phase relationships and amplitudes of the supply current, the disc 14 can produce any shaped motion within the boundaries of its maximum orbit diameter.

Further in the described embodiments the motion of the support/disc 14 relative to the magnetic field means 12 is achieved by having the support/disc 14 movable and the magnetic field means 12 fixed. However this can be reversed so that the support/disc 14 is fixed or stationary and the magnetic field means 12 moves. This may be particularly useful when it is required to impart and maintain, for example a vibratory motion to a large inertial mass. Also, it is preferred that the segments 16 extend through the magnetic field B at right angles to maximize the resultant thrust force. Clearly embodiments of the invention can be constructed where the segments 16 are not at right angles, though it is preferable to have some component of their direction at right angles to the field B to produce a thrust force.

While the invention has been specifically described in connection with certain specific embodiments thereof, it is to be understood that this is by way of illustration and not of limitation, and the scope of the appended claims should be construed as broadly as the prior art will permit.

1. A non-rotary machine comprising a support having a load carrying surface and an opposite surface; an electric motor having an airgap through which lines of magnetic flux extend, and an armature coupled to said support, said armature provided with at least two electrically conductive paths each having at least one current carrying segment disposed in said airgap and substantially perpendicularly intersected by said lines of magnetic flux to produce thrust forces which act to move said armature and thus said support in two dimensions in a plane; and, a bearing support system suspending said armature in said airgap, said bearing support system disposed between said support and said armature.

2. The machine of claim 1 wherein said bearing support system comprises at least three ball roller assemblies, each ball roller assembly comprising a ball roller and a roller support surface on which said ball roller rolls, said roller support surface located in a plane between said support and said armature.

3. The machine of claim 2 wherein each roller support surface comprises a planar surface which is substantially parallel to a plane containing said support.

4. The machine of claim 2 wherein said roller support surface comprises one or more planar surface portions which lie in planes non-parallel to said plane containing said support.

5. The machine of claim 2 wherein each roller support surface comprises a concavely curved surface.

6. The machine of claim 1 further comprising a motor body and a restraint system coupled to said support and said motor body restraining twisting motion of said support.

7. The machine of claim 6 wherein said restraint system comprises a parallelogram arrangement of arms comprising first and second arms pivotally coupled together intermediate their respective lengths, each of said first and second arms having one end resiliently coupled to said motor body.

8. The machine of claim 7 wherein said parallelogram arrangement of arms further comprises a third arm pivotally coupled to an opposite end of said first arm, a fourth arm pivotally coupled to an opposite end of said second arm, and a fifth arm pivotally coupled to both said third and fourth arms and rigidly coupled to said support.

9. The machine of claim 8 further comprising a hub extending axially of and attached to said support and said armature.

10. The machine of claim 9 wherein said fifth arm is rigidly attached to said hub.

11. The machine according to claim 1 further comprising a self centering system which returns said support to a central position relative to said electric motor when said electric motor is not energized.

12. The machine of claim 11 further comprising a hub extending axially of and attached to said support and said armature and wherein said self centering system comprises a rod extending through said hub and resiliently coupled at opposite ends to said support and said motor.

13. The machine according to claim 6 wherein the restraint system comprises a first planar spring coupled to the support and the main body.

14. The machine according to claim 13 wherein the restraint system further comprises a second planar spring coupled to the first planar spring and the main body.

15. The machine according to claim 14 further comprising a rod connecting the first planar spring to the second planar spring.

16. The machine according to claim 15 wherein the rod extends in an axial direction through the armature.

17. The machine according to claim 13 wherein the first planar spring comprises an endless circumferential strip and a plurality of spokes extending radially inward of the strip and joining each other in a central web.

18. The machine according to claim 17 wherein the first planar spring further comprises a plurality of arms, each arm extending radially inward of the strip and terminating in a free end, the free end of each arm being attached to the support.

19. The machine according to claim 14 wherein the second planar spring comprises an endless circumferential strip and a plurality of spokes extending radially inward of the strip and joining in a central web.

20. The machine according to claim 19 wherein the second planar spring further comprises a plurality of lugs extending from the endless circumferential strip of the second planar spring, the lugs being attached to the main body.

21. The machine according to claim 19 wherein the rod is attached to the central webs of the first and second planar springs.
